(19) United States
(12) Patent Application Publication
(10) Pub. No.: US 2025/0105536 A1
(43) Pub. Date: Mar. 27, 2025

(54) CONNECTOR AND MANUFACTURING METHOD THEREOF

(71) Applicant: UNIMICRON TECHNOLOGY CORP., Taoyuan City (TW)

(72) Inventors: Ra-Min TAIN, Taoyuan City (TW); Chunhsien CHIEN, Taoyuan City (TW); Ching-Ho HSIEH, Taoyuan City (TW); Ming-Hsing WU, Taoyuan City (TW)

(73) Assignee: UNIMICRON TECHNOLOGY CORP., Taoyuan City (TW)

(21) Appl. No.: 18/605,597

(22) Filed: Mar. 14, 2024

Related U.S. Application Data
(60) Provisional application No. 63/539,732, filed on Sep. 21, 2023.

(51) Int. Cl. H01R 12/71

(52) U.S. Cl. CPC H01R 12/712

(57) ABSTRACT

A connector and a manufacturing method thereof. The connector includes at least one circuit substrate, at least one contact and a first elastic body. The at least one circuit substrate has a first surface. The at least one contact includes a fixed part and a first contact part that are connected to each other. The fixed part is disposed on the at least one circuit substrate. The first contact part protrudes out of the first surface and covers a part of the first surface. The first elastic body is disposed on the first surface and is electrically insulated. At least a part of the first elastic body is located between the first contact part and the first surface.

### CROSS-REFERENCE TO RELATED APPLICATIONS

This non-provisional application claims priority under 35 U.S.C. § 119 (a) on provisional Patent Application No. 63/539,732 filed in U.S.A. on Sep. 21, 2023, the entire contents of which are hereby incorporated by reference.

### TECHNICAL FIELD

The disclosure relates to a connector and a manufacturing method thereof, more particularly to a connector including at least one contact and a manufacturing method thereof.

### BACKGROUND

In general, the electrical connection between two circuit boards is realized by a connector. In detail, such connector usually includes a circuit substrate and multiple contacts protruding from the circuit substrate. When the contacts are in electrical contact with multiple electrical connection structures in the two circuit boards, the contacts are deformed by being pressed.

However, when the degree of the deformation of the contact increases, a failure, such as fatigue, of the contact may be caused. In this way, the contact is unable to effectively be in electrical contact with the electrical connection structures in the circuit boards, thereby failing to realize the electrical connection between the circuit boards. Thus, in order to prevent the failure of the contact, an expensive material with strong strength, such as beryllium copper or titanium copper, is required to be used to made the contact. That is, in conventional connector, it is hard to prevent the failure of the contact without significantly increasing the manufacture cost of the contact.

### SUMMARY

The disclosure provides a connector and a manufacturing method thereof, which prevent the failure of the contact without significantly increasing the manufacture cost of the contact.

One embodiment of this disclosure provides a connector including at least one circuit substrate, at least one contact and a first elastic body. The at least one circuit substrate has a first surface. The at least one contact includes a fixed part and a first contact part that are connected to each other. The fixed part is disposed on the at least one circuit substrate. The first contact part protrudes out of the first surface and covers a part of the first surface. The first elastic body is disposed on the first surface and is electrically insulated. At least a part of the first elastic body is located between the first contact part and the first surface.

In an embodiment of the disclosure, the first elastic body includes a base part and at least one supporting part. The base part is stacked on the first surface of the at least one circuit substrate. The at least one supporting part protrudes from a side of the base part that is located farthest away from the circuit substrate, and is located between the first contact part and the first surface.

In an embodiment of the disclosure, the first elastic body is in direct contact with the first contact part.

In an embodiment of the disclosure, the at least one circuit substrate further has a second surface facing away from the first surface. The at least one contact further includes a second contact part. The first contact part and the second contact part are connected to two opposite side of the fixed part, respectively. The second contact part protrudes out of the second surface and covers a part of the second surface. The connector further includes a second elastic body. The second elastic body is disposed on the second surface. The at least a part of the second elastic body is located between the second contact part and the second surface.

In an embodiment of the disclosure, the at least one circuit substrate further has a third surface connecting the first surface and the second surface. The fixed part is fixed to the third surface.

In an embodiment of the disclosure, the at least one circuit substrate includes a plurality of circuit substrates. The at least one contact includes a plurality of contacts. The plurality of contacts is arranged in matrix. Each row of the plurality of contacts is located between two adjacent ones of the plurality of circuit substrates.

In an embodiment of the disclosure, the fixed parts of each row of the plurality of contacts are clamped between two adjacent circuit substrates.

In an embodiment of the disclosure, the first contact part and the second contact part bend from the fixed part along one direction.

In an embodiment of the disclosure, the first elastic body is made by rubber or an elastic material that is electrically insulated.

Another embodiment of this disclosure provides a manufacturing method of connector including: providing at least one circuit substrate having a first surface; disposing at least one contact on the at least one circuit substrate, wherein the at least one contact comprises a fixed part and a first contact part that are connected to each other, the fixed part is disposed on the at least one circuit substrate, and the first contact part protrudes out of the first surface and covers a part of the first surface; and disposing a first elastic body that is electrically insulated on the first surface, wherein at least a part of the first elastic body is located between the first contact part and the first surface.

In an embodiment of the disclosure, disposing the first elastic body that is electrically insulated on the first surface includes: forming an elastic material layer that is electrically insulated on the first surface; and forming the first elastic body including a base part and at least one supporting part by removing a part of the elastic material layer by using the first contact part as a mask. The base part is stacked on the first surface. The at least one supporting part protrudes from a side of the base part that is located farthest away from the at least one circuit substrate, and is located between the first contact part and the first surface.

In an embodiment of the disclosure, the at least one circuit substrate includes a plurality of circuit substrates, and the plurality of circuit substrate is bonded to each other in a partially melted state.

In an embodiment of the disclosure, the at least one circuit substrate includes a plurality of circuit substrates, and the plurality of circuit substrates is bonded to each other via an adhesive.

According to the connector and the manufacturing method thereof disclosed by above embodiments, since at least a part of the first elastic body is located between the first contact part and the first surface, the first elastic body decreases the degree of the deformation of the first contact part. Thus, even though the contacts are made by a cheap material with low strength, the first elastic body still can prevent the failure of the contacts. In this way, the failure of the contacts is prevented without significantly increasing the manufacture cost of the contacts.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIGS. 1 to 9 show a manufacturing method of a connector according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

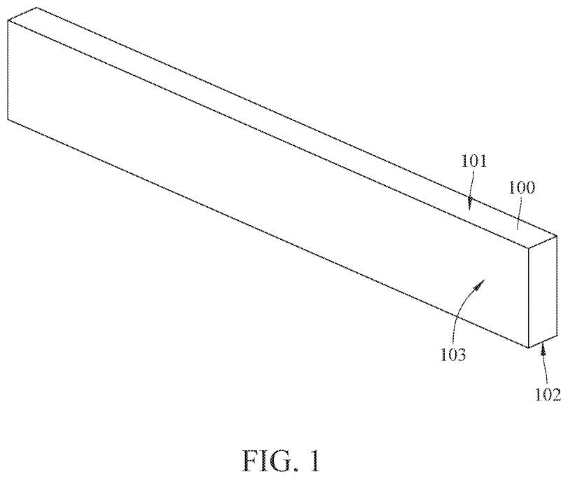

Please refer to FIGS. 1 to 9 showing a manufacturing method of a connector 10 according to one embodiment of the disclosure. The manufacturing method of the connector 10 shown in FIGS. 1 to 9 includes following steps.

As shown in FIG. 1, a circuit substrate 100 having a first surface 101, a second surface 102 and a third surface 103 is provided. The second surface 102 faces away from the first surface 101. The third surface 103 connects the first surface 101 and the second surface 102. The circuit substrate 100 is made by, for example, FR-4 glass epoxy.

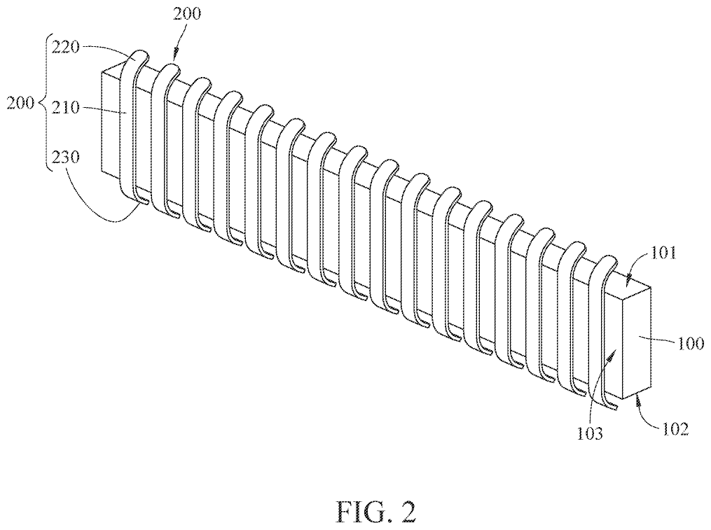

As shown in FIG. 2, a plurality of contacts 200 is disposed on the circuit substrate 100. In detail, in this embodiment, each contact 200 includes a fixed part 210, a first contact part 220 and a second contact part 230, where the first contact part 220 and the second contact part 230 are configured for electrical connection. The fixed part 210 is fixed to the third surface 103 via, for example, pressing or adhering. The first contact part 220 and the second contact part 230 are connected to two opposite sides of the fixed part 210, respectively. The first contact part 220 and the second contact part 230 protrude out of the first surface 101 and the second surface 102, respectively. The first contact part 220 covers a part of the first surface 101, and the second contact part 230 covers a part of the second surface 102. In addition, in this embodiment, the first contact part 220 and the second contact part 230 bend from the fixed part 210 along, for example, the same direction or one direction. That is, the first contact part 220 and the second contact part 230 protrude from the same side of the fixed part 210 so that the fixed part 210, the first contact part 220 and the second contact part 230 are together in, for example, a C-shape. However, the disclosure is not limited thereto. In other embodiments, the first contact part and the second contact part may bend from the fixed part, respectively, along opposite directions so that the fixed part, the first contact part and the second contact part may together be in a S-shape.

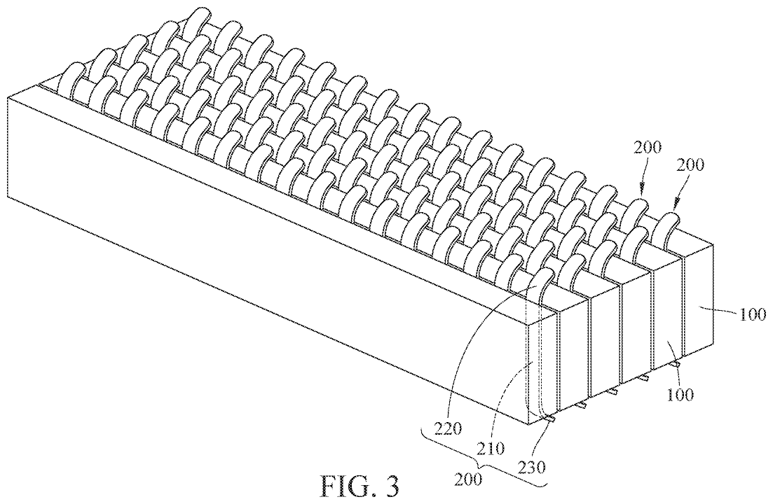

As shown in FIG. 3, a plurality of circuit substrates 100 and a plurality of contacts 200 are provided. The contacts 200 in FIG. 3 are, for example, arranged in a matrix. Also, each row of the contacts 200 is located between two adjacent circuit substrates 100. Specifically, each row of the contacts 200 is clamped between two adjacent circuit substrates 100. Note that in this embodiment or other embodiments, the circuit substrates 100 may be bonded to one another by, for example, an adhesive (not shown). Since the adhesive is thin, the adhesive is omitted from the drawings. Further, the adhesive is filled in a gap between two adjacent circuit substrates 100 to adhere the two adjacent circuit substrates 100 to each other. However, the disclosure is not limited thereto. In this embodiment or other embodiments, the circuit substrates 100 may be directly bonded to one another in a partially melted state without using the adhesive.

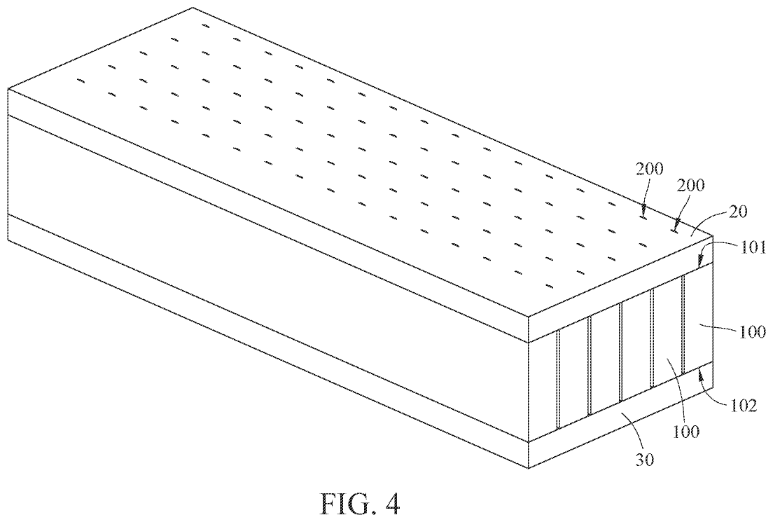

Next, as shown in FIGS. 4 to 9, a first elastic body 300 and a second elastic body 350 that are electrically insulated are provided on the first surface 101 and the second surface 102, respectively.

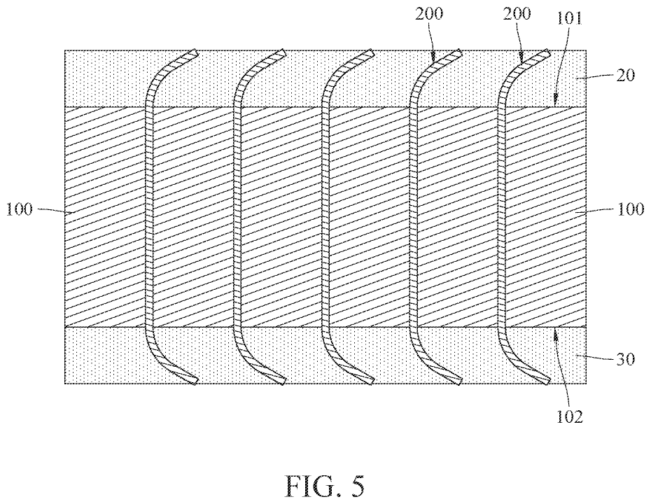

As shown in FIGS. 4 and 5, elastic material layers 20 and 30 that are electrically insulated are formed on the first surfaces 101 and the second surfaces 102 of the circuit substrates 100, respectively.

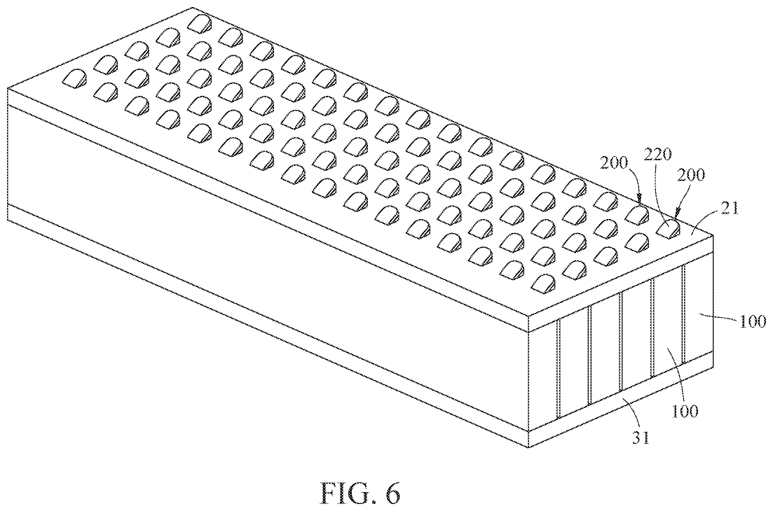

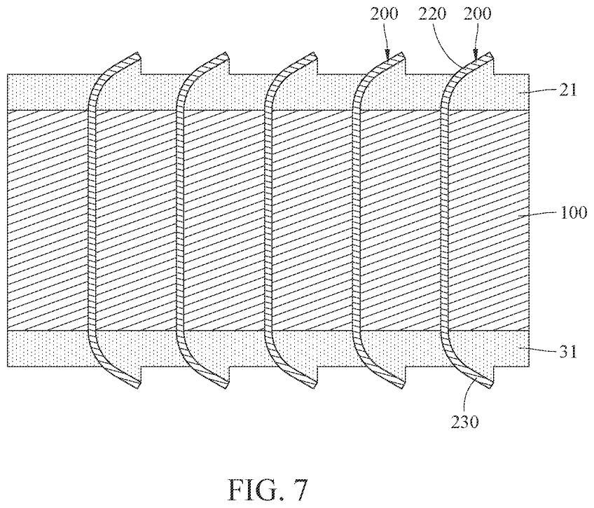

As shown in FIGS. 6 and 7, an elastic byproduct 21 that is electrically insulated is formed by removing a part of the elastic material layer 20 by using the first contact parts 220 as masks, and an elastic byproduct 31 that is electrically insulated is formed by removing a part of the elastic material layer 30 by using the first contact parts 230 as masks. In this embodiment, for example, the step shown in FIGS. 6 and 7 is performed by photolithography, and the elastic material layers 20 and 30 are made by a rubber that is photo-imagable, but the disclosure is not limited thereto. In other embodiments, the step shown in FIGS. 6 and 7 may be performed by dry etching, and the elastic material layers may be made by, for example, silicone, plastic or any other elastic materials that are electrically insulated.

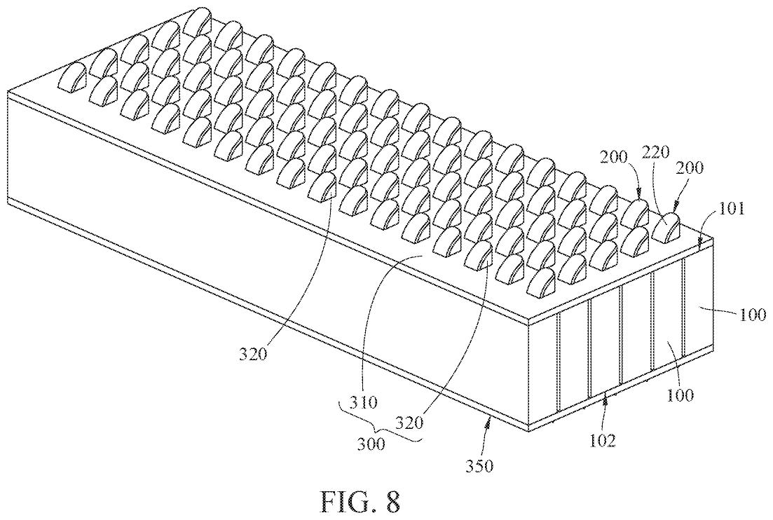

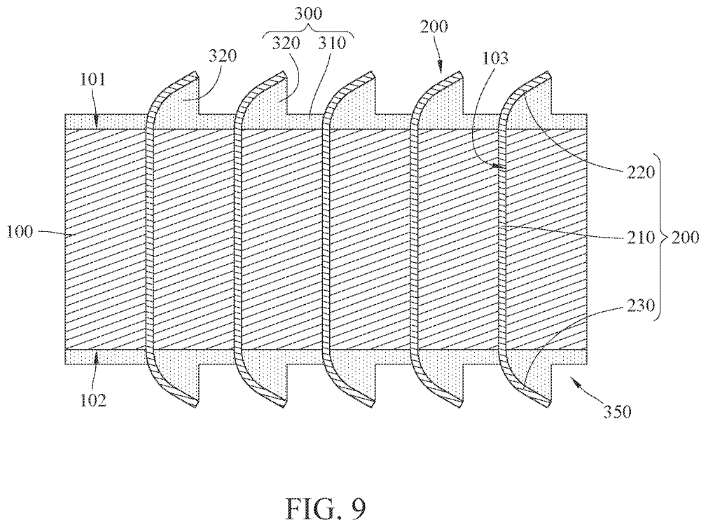

As shown in FIGS. 8 and 9, the first elastic body 300 is formed by removing a part of the elastic byproduct 21 by using the first contact parts 220 as masks, and the second elastic body 350 is formed by removing a part of the elastic byproduct 31 by using the second contact parts 230 as masks. Manufacturing of the connector 10 is completed so far.

In this embodiment, the processes shown in FIGS. 6 to 9 are performed by using the first contact part 220 and the second contact part 230 as masks. Thus, the cost for providing additional masks is saved, thereby reducing the manufacture cost of the first elastic body 300 and the second elastic body 350.

In this embodiment, in order to form the first elastic body 300 and the second elastic body 350, the photolithography process is performed twice on the elastic material layers 20 and 30 in FIGS. 4 and 5, but the disclosure is not limited thereto. In other embodiments, the step shown in FIGS. 6 and 7 may be omitted, and the first elastic body 300 and the second elastic body 350 may be formed by removing a part of the elastic material layers 20 and 30 once; alternatively, the step shown in FIGS. 8 and 9 may be omitted, and the elastic byproducts 21 and 31 may be used as the final first elastic body 300 and the final second elastic body 350, respectively.

Note that since the first elastic body 300 and the second elastic body 350 are similar in structure, and are disposed on the circuit substrate 100 in a similar manner, only the detail structure and the arrangement of the first elastic body 300 will be described hereinafter.

The first elastic body 300 includes a base part 310 and a plurality of supporting parts 320. The base part 310 is stacked on the first surface 101 of the circuit substrate 100. The supporting parts 320 protrude from a side of the base part 310 that is located farthest away from the circuit substrate 100, and are located between the first contact parts 220 and the first surface 101. Moreover, in this embodiment, the supporting parts 320 are in direct contact with the first contact parts 220, respectively, so as to facilitate the supporting parts 320 to decrease the degree of the deformation of the first contact parts 220, but the disclosure is not limited thereto. In other embodiments, the supporting parts may be spaced apart from the first contact parts, respectively; in such embodiments, the first contact parts may be in contact with and thus support the first contact parts after a certain degree of deformation thereof.

In this embodiment, the base part 310 not only connects the supporting parts 320 to enhance the overall structural strength of the first elastic body 300, but also facilitates the formation of the first elastic body 300. However, in other embodiments, without considering the complexity of the manufacture process, the first elastic body may not include the base part.

Although not shown in the drawings, the connector 10 according to this disclosure is, for example, configured to electrically connect two electronic components, for example, two circuit boards or one electronic component and one circuit board by the contacts 200. However, the disclosure is not limited by the structure of the contacts 200. In other embodiments, the second contact part of each contact may be replaced by a solder ball.

Note that the disclosure is not limited by the number of the circuit substrates and the number of the contacts. In other embodiments, there may be a single circuit substrate and a single row of contacts (as shown in FIG. 2); alternatively, in still other embodiments, there may be a single contact, and there may be a single supporting part correspondingly.

According to the connector and the manufacturing method thereof disclosed by above embodiments, since at least a part of the first elastic body is located between the first contact part and the first surface, the first elastic body decreases the degree of the deformation of the first contact part. Thus, even though the contacts are made by a cheap material with low strength, the first elastic body still can prevent the failure of the contacts. In this way, the failure of the contacts is prevented without significantly increasing the manufacture cost of the contacts.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A connector, comprising:
at least one circuit substrate, having a first surface;
at least one contact, comprising a fixed part and a first contact part that are connected to each other, wherein the fixed part is disposed on the at least one circuit substrate, and the first contact part protrudes out of the first surface and covers a part of the first surface; and
a first elastic body, disposed on the first surface and being electrically insulated, wherein at least a part of the first elastic body is located between the first contact part and the first surface.

2. The connector according to claim 1, wherein the first elastic body comprises a base part and at least one supporting part, the base part is stacked on the first surface of the at least one circuit substrate, and the at least one supporting part protrudes from a side of the base part that is located farthest away from the circuit substrate, and is located between the first contact part and the first surface.

3. The connector according to claim 1, wherein the first elastic body is in direct contact with the first contact part.

4. The connector according to claim 1, wherein the at least one circuit substrate further has a second surface facing away from the first surface, the at least one contact further comprises a second contact part, the first contact part and the second contact part are connected to two opposite side of the fixed part, respectively, the second contact part protrudes out of the second surface and covers a part of the second surface, the connector further comprises a second elastic body, the second elastic body is disposed on the second surface, and at least a part of the second elastic body is located between the second contact part and the second surface.

5. The connector according to claim 4, wherein the at least one circuit substrate further has a third surface connecting the first surface and the second surface, and the fixed part is fixed to the third surface.

6. The connector according to claim 5, wherein the at least one circuit substrate comprises a plurality of circuit substrates, the at least one contact comprises a plurality of contacts, the plurality of contacts is arranged in matrix, and each row of the plurality of contacts is located between two adjacent ones of the plurality of circuit substrates.

7. The connector according to claim 6, wherein the fixed parts of each row of the plurality of contacts are clamped between two adjacent ones of the plurality of circuit substrates.

8. The connector according to claim 4, wherein the first contact part and the second contact part bend from the fixed part along one direction.

9. The connector according to claim 1, wherein the first elastic body is made by rubber or an elastic material that is electrically insulated.

10. A manufacturing method of connector, comprising:
providing at least one circuit substrate having a first surface;
disposing at least one contact on the at least one circuit substrate, wherein the at least one contact comprises a fixed part and a first contact part that are connected to each other, the fixed part is disposed on the at least one circuit substrate, and the first contact part protrudes out of the first surface and covers a part of the first surface; and
disposing a first elastic body that is electrically insulated on the first surface, wherein at least a part of the first elastic body is located between the first contact part and the first surface.

11. The manufacturing method of connector according to claim 10, wherein disposing the first elastic body that is electrically insulated on the first surface comprises:
forming an elastic material layer that is electrically insulated on the first surface; and
forming the first elastic body comprising a base part and at least one supporting part by removing a part of the elastic material layer by using the first contact part as a mask, wherein the base part is stacked on the first surface, and the at least one supporting part protrudes from a side of the base part that is located farthest away from the at least one circuit substrate, and is located between the first contact part and the first surface.

12. The manufacturing method of connector according to claim 10, wherein the at least one circuit substrate comprises a plurality of circuit substrates, and the plurality of circuit substrate is bonded to each other in a partially melted state.

13. The manufacturing method of connector according to claim 10, wherein the at least one circuit substrate comprises a plurality of circuit substrates, and the plurality of circuit substrates is bonded to each other via an adhesive.
